(19) United States
(12) Patent Application Publication
(10) Pub. No.: US 2026/0245479 A1
(43) Pub. Date: Aug. 20, 2026

(54) Raised Dot Tactile Smartphone Screen Protector and Integrated Accessibility Application

(71) Applicant: Michael Robinson, Atlanta, GA (US)

(72) Inventor: Michael Robinson, Atlanta, GA (US)

(21) Appl. No.: 19/369,053

(22) Filed: Oct. 24, 2025

Related U.S. Application Data
(60) Provisional application No. 63/711,830, filed on Oct. 25, 2024.

(51) Int. Cl. G09B 21/00; G06F 3/01; G06F 3/0488; G06F 3/16; H04M 1/72409; H04M 1/72481

(52) U.S. Cl. CPC G09B 21/007; H04M 1/72409; H04M 1/72481; G06F 3/016; G06F 3/0488; G06F 3/167; H04M 2201/38; H04M 2201/42

(57) ABSTRACT

The present invention, termed Raised Dot, provides an integrated system for rendering smartphones and electronic devices fully accessible to visually impaired users. The system comprises a physical interactive overlay and an associated mobile application that dynamically reconfigures the device's display and interaction protocols. The overlay is a transparent, durable shield with an adhesive backing, featuring an input region with tactile markers such as raised dots, lines, and geometric shapes. These raised areas serve as a physical guide, allowing a user to locate, tap, or swipe specific screen areas with precision. The core functionality is provided by the application, which is configured to reconfigure the device's display to meticulously align its user interface elements with the tactile grid of the overlay. The application alters the interaction paradigm by implementing a dual-tap interaction protocol with a single tap triggers an audio description of the function, while a double-tap executes the command.

### CROSS REFERENCE TO RELATED APPLICATIONS

This application claims the benefit of U.S. Provisional Application US 63/711,830 filed Oct. 25, 2024, which is incorporated herein by reference.

### TECHNICAL FIELD

The invention is directed to an application (app) and an interactive overlay system for converting the display configuration of a smartphone or other electronic device to align with the interactive overlay to be placed on the face of the device. The overlay is designed for the visually impaired and includes a series of raised areas, including dots, lines, and specific geometric shapes.

### BACKGROUND OF THE INVENTION

The rapid proliferation of smartphones and advanced computing technologies has ushered in an era of unprecedented connectivity and convenience. This revolution, however, has not been equally beneficial for all users, particularly the visually impaired. Current estimates indicate that millions of people nationwide live with significant visual challenges, a demographic whose unique needs are often underserved by modern mobile technology.

Contemporary smartphone design has largely converged on a sleek, featureless flat glass touchscreen interface. While aesthetically pleasing and versatile, this design paradigm eliminates the crucial tactile feedback that was inherent in older mobile phones equipped with physical buttons and keypads. The absence of palpable input options renders many fundamental tasks, such as answering a call, dialing a number, or navigating an application, difficult, if not impossible, for individuals who cannot see their screen.

Existing software-based accessibility features, such as screen readers and voice commands, offer some assistance but often require a level of screen interaction and navigation that is still challenging for the unsighted user. There is a pressing need for a seamless, intuitive, and integrated solution that converts the flat, non-tactile surface of a smartphone screen into an accessible, tactile, and predictable interface. This invention addresses this need by providing a novel system combining a physical tactile overlay with a dedicated software application to restore usability and independence for visually challenged users.

### SUMMARY

In one aspect the invention is an interactive overlay and an application system for converting the display configuration of a smartphone to align with the interactive overlay to be placed on the face of the smartphone device. In this aspect, the protective overlay has at least one input region specifically arranged for a seeing impaired user. The input region includes a series of input buttons with raised areas, including dots, lines, and geometric shapes. According to the invention, the app interacts with the smartphone, accesses the smartphone display, and reconfigures the smartphone display to match and align with the interactive overlay. The application receives the input and configures the phone to call up the corresponding API or to activate the required function.

In this aspect the application includes input recognition for detecting and validating a double-tap gesture, confirming it matches a dual-tap interaction protocol. The application also includes location mapping for identifying which specific tactile zone was activated and cross-references it with a stored grid-based layout to determine the intended function. The application further includes function determination, utilizing a contextual audio mapping system, so that the application determines what specific action corresponds to that tactile position, so that the app receives the input and processes the user's request. In this aspect, the application also includes input recognition, so that the application detects and validates the double-tap gesture, confirming it matches said dual-tap interaction protocol. Location mapping is also provided, wherein the application identifies which specific tactile zone was activated and cross-references the zone with a stored grid-based layout to determine the intended function. In this aspect, the application also includes function determination, which utilizes a contextual audio mapping system, so that the application determines what specific action corresponds to that tactile position. The application further includes system configuration, wherein the application configures the phone's relevant subsystems, including audio, haptic feedback, and visual interface, to prepare for the requested function. Action Execution is also provided, wherein the application calls the appropriate external API or system function, and Feedback Delivery, wherein the application provides confirmation through coordinated audio announcements and haptic vibration patterns to the user.

In a second aspect, the invention is a method for providing tactile-based accessibility for a visually impaired user of an electronic device. In this aspect, the method includes the steps of placing an overlay on a screen of a electronic device, wherein the screen is an interactive surface for receiving user inputs. The method also includes the locating by the user a specific area on the protective shield using a raised tactile area to navigate the device's screen. In this aspect, the method also includes, receiving a single tap input from the user, and in response, the electronic device verbally describes the function of the specific button corresponding to the located area. The method also includes, receiving a double tap input from the user to activate the function of the button, and upon receiving the double tap input, configuring the electronic device xxx to call up the corresponding API or to activate the required function.

In the method according to this aspect, the application includes input recognition for detecting and validating a double-tap gesture, confirming it matches a dual-tap interaction protocol. The application also includes location mapping for identifying which specific tactile zone was activated and cross-references it with a stored grid-based layout to determine the intended function. The application further includes function determination, utilizing a contextual audio mapping system, so that the application determines what specific action corresponds to that tactile position, so that the app receives the input and processes the user's request. In the method according to this aspect, the application also includes input recognition, so that the application detects and validates the double-tap gesture, confirming it matches said dual-tap interaction protocol. Location mapping is also provided, wherein the application identifies which specific tactile zone was activated and cross-references the zone with a stored grid-based layout to determine the intended function. In the method according to this aspect, the application also includes function determination, which utilizes a contextual audio mapping system, so that the application determines what specific action corresponds to that tactile position. The application further includes system configuration, wherein the application configures the phone's relevant subsystems, including audio, haptic feedback, and visual interface, to prepare for the requested function. Action Execution is also provided, wherein the application calls the appropriate external API or system function, and Feedback Delivery, wherein the application provides confirmation through coordinated audio announcements and haptic vibration patterns to the user.

### BRIEF DESCRIPTION OF THE DRAWINGS

FIG. 1A is an exemplary illustration of an interactive overlay for an electronic device, according to an embodiment of the invention.

FIG. 1B is an exemplary illustration of a single interactive overlay for an electronic device, according to an embodiment of the invention.

FIG. 1C is an exemplary illustration of overlays, according to embodiments of the invention.

FIG. 1D is an exemplary illustration of a single multi-use interactive overlay for an electronic device, according to an embodiment of the invention.

FIG. 2 is a schematic illustration of the intelligent mobile application for providing tactile-based accessibility for a visually impaired user of an electronic device, according to an embodiment of the invention.

FIG. 3 is an exemplary flowchart, illustrating a method for providing tactile-based accessibility for a visually impaired user of an electronic device, according to an embodiment of the invention.

### DETAILED DESCRIPTION

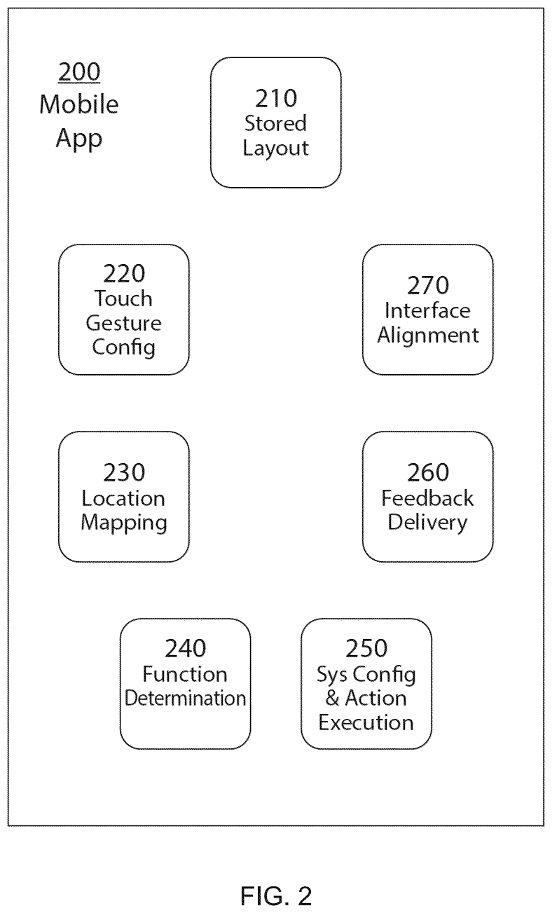

The present invention, termed Raised Dot, is an integrated system designed to make smartphones fully accessible and functional for unsighted and low-sighted users. The system is comprised of two core components: a physical interactive overlay (or screen protector) with tactile features, and a mobile application 200 (See FIG. 2) that dynamically reconfigures the electronic device's display and interaction protocols to align with the overlay. It is understood that throughout this written description, “Application 200” and “App 200” are used interchangeably.

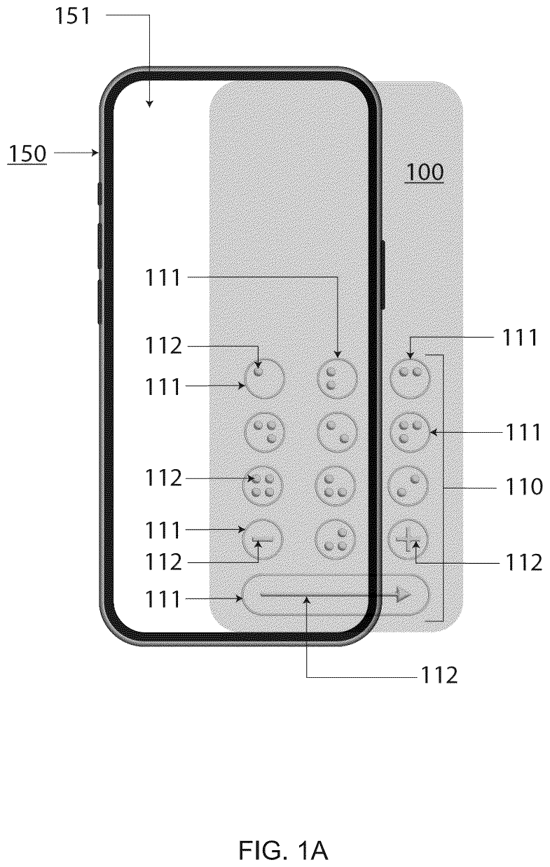

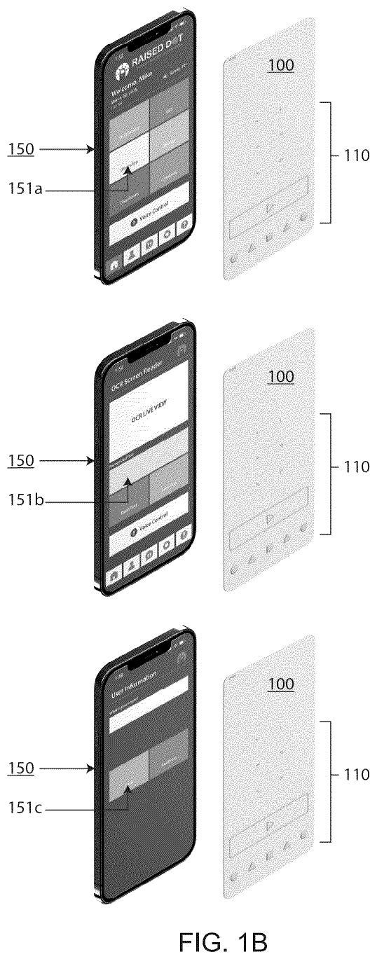

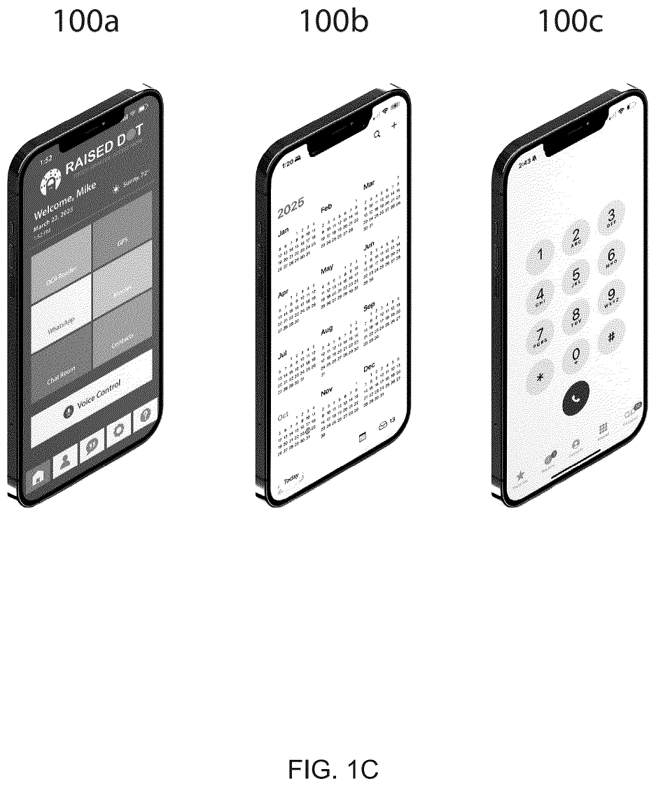

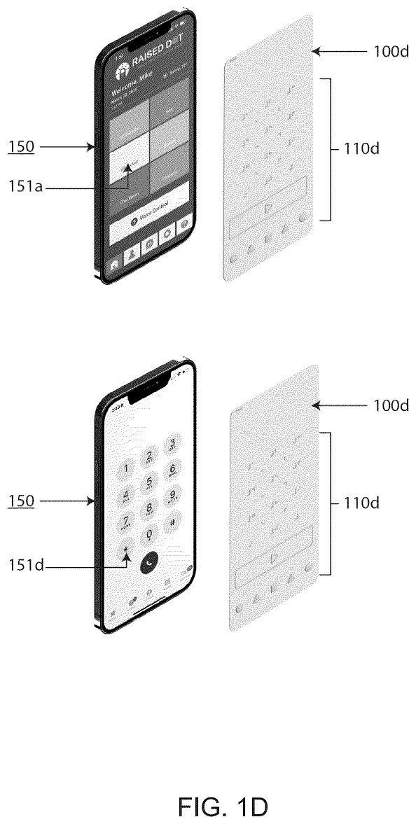

FIG. 1A is an exemplary illustration of an interactive overlay 100 for an electronic device 150, according to an embodiment of the invention. The electronic device 150 may be a smartphone, mobile phone, music device, tablet, or any known smart device having a smart screen that allows a user to input commands, information, or the like. In other words, the electronic device 150 may be a known mobile device having a smart screen/display and one or more processors and memories for executing its associated functions. According to an embodiment of the invention, the interactive overlay 100 is a raised dot interactive overlay which is a physical shield. The overlay 100 may be made from a thin, transparent, and durable plastic material configured to maintain the smartphone's underlying touch sensitivity. The back surface of the overlay 100 has an adhesive backing for durable application to the screen/display 151 of the electronic device 150.

FIG. 1A shows the front surface of the overlay 100 having an input region 110 designed for persons who are visually impaired. As shown in FIG. 1A, the input region 110 includes a series of input buttons 111 with raised areas 112, including dots, lines, and specific geometric shapes (like hemispheres or outlines) that are molded or attached to the surface. These input buttons 111 and raised areas 112 serve as tactile markers specifically arranged for a seeing-impaired user, allowing them to locate, press, tap, or swipe specific areas of the screen with precision. The overlay is entirely passive; it functions purely as a physical guide, providing tactile cues so visually impaired users know where to press.

The input region 110 including the input buttons 111 and raised areas 112 are designed to align with the mobile application's reconfigured user interface. For example, a raised rectangular outline on the overlay 100 may correspond to the area a user swipes to answer a phone call. A grid of raised braille characters may correspond to the layout of reconfigured, high-contrast digital “buttons” on the app-initiated screen. Each physical input button on the overlay 100 aligns to provide a distinct, recognizable tactile identifier.

It is understood that the application 200 (FIG. 2) is equipped to reconfigure the screen/display of an electronic device 150 to align or match with a single overlay 100. FIG. 1B is an exemplary illustration of a single interactive overlay 100 for an electronic device 150, according to an embodiment of the invention. As shown in FIG. 1B, the electronic device 150 is a smartphone, having a screen/display 151. FIG. 1B shows the device 150 having different displays 151a, 151b, and 151c, which may represent distinct illustrations from a single mobile application. The overlay 100 in each illustration in FIG. 1B represents the same overlay. As shown in FIG. 1B, according to this particular embodiment, the input region 110 including the input buttons 111 with raised areas 112, of the single overlay 100 are applicable and match and align with each display (151a, 151b, 151c) of the particular phone app. As outlined below, this is a function of the app 200 that dynamically reconfigures the smartphone so that each screen/display aligns with the overlay 100.

Different electronic device operations involving different apps may be configured to use this single overlay 100. So, for example, a smartphone may have different functions such as a phone calling screen, or a calendar screen, according to the phone-app being used. The app 200 may reconfigure the screens associated with these apps to work with that single overlay 100.

FIG. 1C is an exemplary illustration of a plurality of overlays 100a, 100b, and 100c, according to embodiments of the invention. According to embodiments of the invention, there are a plurality of protective overlays (100a, 100b, 100c) or shields, each providing different functionality, each designed specifically for a different app or operation of the electronic device 150. According to an embodiment of the invention, a user selects the overlay that best suits their needs at the time of use. For example, a “Social Media” overlay 100a may have raised areas that act as shortcuts to various social media platforms. An “Organizational” overlay 100b may feature shortcuts to calendar, reminders, and office tools. A “Keypad” overlay 100c may be used for a numerical or telephonic inputs.

FIG. 1D is an exemplary illustration of a single multi-use interactive overlay for an electronic device, according to an embodiment of the invention. The overlay 100d has an input region 110d designed for persons who are visually impaired. As the case with the illustration of FIG. 1A, the input region 100d may include a series of input buttons with raised areas, including dots, lines, and specific geometric shapes (like hemispheres or outlines) that are molded or attached to the surface. In this particular embodiment, the input region is designed to align and function with to different distinct phone apps. The displays 151a and 151d represent two distinct apps for which the same overlay 100d can be used. This is in contrast to the embodiment of FIG. 1C for which different overlays (100a, 100b, 100c) are swapped out to fit a particular mobile app or function.

FIG. 2 is a schematic illustration of the intelligent mobile application 200 for providing tactile-based accessibility for a visually impaired user of a electronic device, according to an embodiment of the invention. The raised dot application (app) 200 is installed on the electronic device 150, which may be a smartphone, tablet, or the like, and works in tandem with the physical overlay 100. The raised dot application 200 functions as the crucial interface that receives and interprets the user's tactile inputs, translating them into corresponding digital commands for the phone's operating system and other installed applications.

The application 200 primary functions to reconfigure the smartphone display to match and align with the interactive overlay. During a setup process, the user places the overlay 100 on the device 150. The app loads a stored grid-based layout 210 for interpretation. As outlined below, this ensures the accurate alignment of the mobile device screen with the overlay 100, and in particular alignment between the input buttons 111 of the input region 110, and the device screen.

The application 200 alters the device's interaction paradigms through several configuration modules, including utilizing a touch gesture configuration 220, location mapping function 230, function determination 240, system configuration and action execution 250, feedback delivery 260, and a display and interface alignment function 270.

The touch gesture configuration 220 function operates as follows. The application 200 reconfigures the device's standard touch recognition system by implementing a dual-tap interaction protocol. Single taps trigger audio descriptions without activation, verbally describing the function of the corresponding button/zone (e.g., “Call Button”). Double-taps execute the corresponding function. The app detects and validates the double-tap gesture, confirming it matches the dual-tap interaction protocol. Regarding the Location Mapping 230, when a user taps, the application 200 identifies which specific tactile zone was activated and cross-references it with the stored grid-based layout to determine the intended function.

Function determination 240 utilizes a contextual audio mapping system. The app 200 determines the specific action. For example, when the device 150 is a mobile phone operating within the purview of traditional phone functions, the specific action may be, “make a call,” or “send a text”, which corresponds to the tactile position. At System Configuration & Action Execution 250 the app configures the relevant subsystems (audio, haptic feedback, visual interface) of the electronic device 150, to prepare for the requested function. Here, the app then configures the electronic device 150 to call up the corresponding Application Programming Interface (API) to activate the required function, such as for example, launching an external app, sending a message. The app 200 also includes a Feedback Delivery function 260. Here the app provides confirmation through coordinated audio announcements and haptic vibration patterns to confirm the action was successfully initiated.

By calling the Display and Interface Alignment function 270, the visual interface of the app is meticulously adapted to align with the tactile overlay 100. By utilizing the grid-based Layout Enforcement, the app 200 restructures the underlying User Interface (UI) elements to precisely match the grid pattern of the tactile overlay. This reconfigures display elements such as button size, spacing, layout, icon sizing, and menu arrangement. Icon positioning is also provided. Visual elements are precisely aligned with the raised tactile markers shown in FIGS. 1A and 1B. According to an embodiment of the invention, the display and interface alignment function 270 also provides a Color-coding System. High-contrast color schemes are implemented that correspond to the tactile zones, aiding users with low-sightedness.

This process and functions provided by the app 200 ensures that the physical tactile interaction seamlessly translates into the appropriate digital response. This is done while maintaining a comprehensive, accessibility-focused feedback system. The application allows users to perform essential functions such as, opening the phone, answering calls, dialing numbers, typing messages, and operating other installed applications.

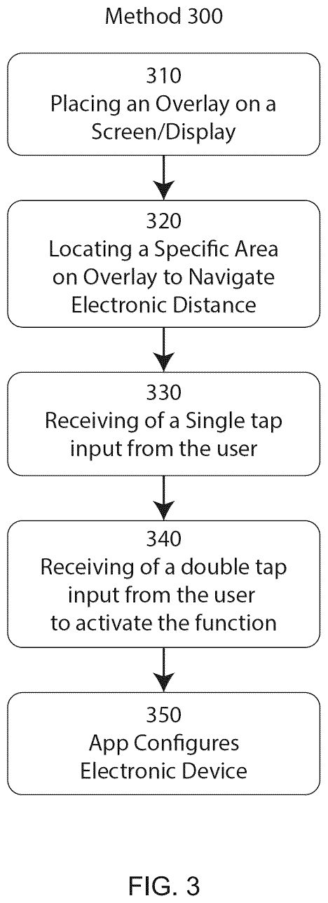

FIG. 3 is an exemplary flowchart, illustrating a method 300 for providing tactile-based accessibility for a visually impaired user of an electronic device, according to an embodiment of the invention. As stated above, the electronic device 150 may be a smartphone, mobile phone, music device, tablet, or any known smart device having a smart screen that allows a user to input commands, information, or the like. The electronic device 150 may be a known mobile device having a smart screen/display and one or more processors and memories for executing its associated functions.

As shown, 310 is the placing of an overlay 100 on a screen 151 of a electronic device 150. According to the invention, the screen is an interactive surface for receiving user inputs. According to the process, 320 is the locating, by the user, a specific area on the overlay 100, using a raised tactile area to navigate the device's screen. As illustrated in the flowchart of FIGS. 3, 330 is the receiving of a single tap input from the user, and in response, verbally describing (to the user) the function of the specific button corresponding to the located area. Next, 340 is the receiving of a double tap input from the user to activate the function of the button.

FIG. 3 also shows 350, wherein upon receiving the double tap input, the app configures the electronic device to call up the corresponding API or to activate the required function. According to the method 300, the application 200 processes the user's request by utilizing the stored grid-based layout 210, the touch gesture configuration 220, the location mapping function 230, the function determination 240, the system configuration and action execution 250, the feedback delivery 260, and the display and interface alignment function 270. The description of these functions are outlined above with reference to the application 200 and FIG. 2.

What has been described and illustrated herein are preferred embodiments of the invention along with some variations. The terms, descriptions and figures used herein are set forth by way of illustration only and are not meant as limitations. Those skilled in the art will recognize that many variations are possible within the spirit and scope of the invention. For example, it is within the scope of this invention to have any of the outlined overlays, permanently affixed to a screen. The invention including the stated variations is intended to be defined by the following claims and their equivalents, in which all terms are meant in their broadest reasonable sense unless otherwise indicated.

1. An interactive overlay and an application system for converting the display configuration of a smartphone to align with the interactive overlay to be placed on the face of the smartphone device,
wherein the protective overlay comprises at least one input region specifically arranged for a seeing impaired user, wherein the input region includes a series of input buttons with raised areas, including dots, lines, and geometric shapes,
and wherein the application interacts with the smartphone, accesses the smartphone display, and reconfigures the smartphone display to match and align with the interactive overlay, and wherein the application receives the input and configures the phone to call up the corresponding API or to activate the required function,
wherein the application comprises;
input recognition for detecting and validating a double-tap gesture, confirming it matches a dual-tap interaction protocol,
location mapping for identifying which specific tactile zone was activated and cross-references it with a stored grid-based layout to determine the intended function,
function determination, utilizing a contextual audio mapping system, wherein the application determines what specific action corresponds to that tactile position, so that the application receives the input and processes the user's request,
input recognition, wherein the application detects and validates said double-tap gesture, confirming it matches said dual-tap interaction protocol;
location mapping, wherein, the application identifies which specific tactile zone was activated and cross-references it with a stored grid-based layout to determine the intended function,
function determination, utilizing a contextual audio mapping system, the application determines what specific action corresponds to that tactile position,
system configuration, wherein the application configures the phone's relevant subsystems, including audio, haptic feedback, and visual interface, to prepare for the requested function,
action execution, wherein the application calls the appropriate external API or system function, and
feedback delivery, wherein the application provides confirmation through coordinated audio announcements and haptic vibration patterns to the user.

2. The interactive overlay and an application system of claim 1, wherein in providing the accessing of the smartphone display and the reconfiguring of the smartphone display to match and align with the interactive overlay, the application further provides a Color-coding System, wherein high-contrast color schemes are implemented that correspond to the tactile zone, for aiding users with low-sightedness.

3. A method for providing tactile-based accessibility for a visually impaired user of a electronic device, the method comprising:
placing an overlay on a screen of an electronic device, wherein the screen is an interactive surface for receiving user inputs;
locating, by the user, a specific area on the protective shield using a raised tactile area to navigate the device's screen;
receiving a single tap input from the user, and in response, a phone verbally describing the function of the specific button corresponding to the located area;
receiving a double tap input from the user to activate the function of the button;
receiving, by an application, the double tap input and configuring the phone to call up the corresponding API or to activate the required function, wherein the application processes the user's request by utilizing:
input recognition for detecting and validating a double-tap gesture, confirming it matches a dual-tap interaction protocol,
location mapping for identifying which specific tactile zone was activated and cross-references it with a stored grid-based layout to determine the intended function,
function determination, utilizing a contextual audio mapping system, wherein the application determines what specific action corresponds to that tactile position, so that the application receives the input and processes the user's request,
input recognition, wherein the application detects and validates said double-tap gesture, confirming it matches said dual-tap interaction protocol;
location mapping, wherein, the application identifies which specific tactile zone was activated and cross-references it with a stored grid-based layout to determine the intended function,
function determination, utilizing a contextual audio mapping system, the application determines what specific action corresponds to that tactile position,
system configuration, wherein the application configures the phone's relevant subsystems, including audio, haptic feedback, and visual interface, to prepare for the requested function,
action execution, wherein the application calls the appropriate external API or system function, and
feedback delivery, wherein the application provides confirmation through coordinated audio announcements and haptic vibration patterns to the user.

4. The method of claim 3 for providing tactile-based accessibility for a visually impaired user, wherein the electronic device is a smartphone, and placing of an overlay on a screen of the electronic device, comprises selecting one of a plurality of distinct overlays, wherein said selected overlay is designed for a specific smartphone application.
